(19) United States
(12) Patent Application Publication
(10) Pub. No.: US 2026/0254248 A1
(43) Pub. Date: Aug. 27, 2026

(54) LOAD BALANCING AND CONTROL OF LOCAL BATTERIES FOR COMMUNICATION SYSTEM

(71) Applicant: Telefonaktiebolaget LM Ericsson (publ), Stockholm (SE)

(72) Inventors: Hossein SHOKRI GHADIKOLAEI, Täby (SE); Lackis ELEFTHERIADIS, VALBO (SE)

(73) Assignee: Telefonaktiebolaget LM Ericsson (publ), Stockholm (SE)

(21) Appl. No.: 19/160,078

(22) PCT Filed: Mar. 1, 2023
(86) PCT No.: PCT/IB2023/051908

§ 371 Date: Aug. 27, 2025

(51) Int. Cl. H02J 3/32; H02J 7/00; H02J 7/50; H02J 7/90

(52) U.S. Cl. CPC H02J 3/32; H02J 7/585; H02J 7/855; H02J 7/933

(57) ABSTRACT

A computer-implemented method is provided performed by a computing device (300, 900) for load balancing and control of a plurality of local batteries located proximate a plurality of radio heads for a communication system. The method includes determining (802), for a future time window, a decision about delivery of power from respective local batteries in the plurality of local batteries to respective radio heads in the plurality of radio heads and a balance of respective loads for the respective radio heads for a future time window. The method further includes outputting (804) the decision to the respective radio heads for the future time window. The decision about delivery of power and a balance of respective loads is determined with an objective to minimize a total cost of power.

### TECHNICAL FIELD

The present disclosure relates generally to a computer-implemented method performed by a computing device for load balancing and control of a plurality of local batteries located proximate a plurality of radio heads for a communication system, and related methods and apparatuses.

### BACKGROUND

The mobile communications sector may experience an ever-increasing energy consumption due to the explosion of new services and network traffic loads. A radio access network (RAN) can be responsible for a large part of the energy consumption of mobile networks. Increasing the number of radio heads is one practice to extend capacity, coverage, and service quality. However, increasing the number of radio heads entails further expanding a site with more radios, which increases the energy consumption when adding more radio heads on site with various radio access technologies (RATs) and bands.

Existing and future RAN features (e.g., micro sleep transmission (Tx), Low Energy Scheduler Solution (LESS), massive input massive output (MIMO) sleep mode, cell sleep mode, etc.) may increase sleep time duration (and therefore reduce the power consumption) of the radio heads. However, higher traffic demands lead to higher energy consumption. For example, whereas fifth generation (5G) technology may be significantly more energy-efficient than fourth generation (4G) technology, a higher amount of traffic is still expected to increase the total energy consumption of a 5G base station (BS) by as much as 70% compared to that of a 4G BS, for example.

### SUMMARY

There currently exist certain challenges. Approaches are lacking to better manage and reduce total energy consumption to avoid, e.g., an increase in monetary cost and carbon footprint. Present technology for mobile network site infrastructure energy storage, for example, may limit the design and use of a local battery to a backup battery in the event of a power outage. Joint optimization of load balancing for multiple BSs and control of local batteries is lacking.

Certain aspects of the disclosure and their embodiments may provide solutions to these or other challenges.

In some embodiments, a computer-implemented method performed by a computing device is provided for load balancing and control of a plurality of local batteries located proximate a plurality of radio heads for a communication system. The includes determining, for a future time window, a decision about delivery of power from respective local batteries in the plurality of local batteries to respective radio heads in the plurality of radio heads and a balance of respective loads for the respective radio heads for a future time window. The method further includes outputting the decision to the respective radio heads for the future time window. The decision about delivery of power and a balance of respective loads is determined with an objective to minimize a total cost of power.

In some embodiments, a computing device is provided for load balancing and control of a plurality of local batteries located proximate a plurality of radio heads for a communication system. The computing device includes at least one processor; and at least one memory connected to the at least one processor. The at least one memory stores program code that is executed by the at least one processor to perform operations. The operations include to determine, for a future time window, a decision about delivery of power from respective local batteries in the plurality of local batteries to respective radio heads in the plurality of radio heads and a balance of respective loads for the respective radio heads for a future time window. The operations further include to output the decision to the respective radio heads for the future time window. The decision about delivery of power and a balance of respective loads is determined with an objective to minimize a total cost of power.

In some embodiments, a computer program is provided that includes program code to be executed by at least one processor of a computing device for load balancing and control of a plurality of local batteries located proximate a plurality of radio heads for a communication system. Execution of the program code causes the computing device to performs operations. The operations include to determine, for a future time window, a decision about delivery of power from respective local batteries in the plurality of local batteries to respective radio heads in the plurality of radio heads and a balance of respective loads for the respective radio heads for a future time window. The operations further include to output the decision to the respective radio heads for the future time window. The decision about delivery of power and a balance of respective loads is determined with an objective to minimize a total cost of power.

In some embodiments, a computer program product is provided that includes a non-transitory storage medium that includes program code to be executed by at least one processor of a computing device for load balancing and control of a plurality of local batteries located proximate a plurality of radio heads for a communication system. Execution of the program code causes the computing device to perform operations. The operations include to determine, for a future time window, a decision about delivery of power from respective local batteries in the plurality of local batteries to respective radio heads in the plurality of radio heads and a balance of respective loads for the respective radio heads for a future time window. The operations further include to output the decision to the respective radio heads for the future time window. The decision about delivery of power and a balance of respective loads is determined with an objective to minimize a total cost of power.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a conventional site deployment with three radio heads;

FIG. 2 is a schematic diagram illustrating an example of adding more radio heads to the existing example site deployment shown in FIG. 1;

FIG. 3 is a schematic diagram illustrating an example of a RAN with multiple BSs that respectively have one or multiple local batteries according to some embodiments;

FIG. 4 is a schematic diagram illustrating a general architecture according to some embodiments;

FIG. 5 is a schematic diagram illustrating another general architecture according to some embodiments;

FIG. 6 is a sequence diagram illustrating an example of machine learning-based load balancing and local battery management service according to some embodiments;

FIG. 7 is a sequence diagram illustrating an example of an optimization theory-based load balancing and local battery management service according to some embodiments;

FIG. 8 is a flow chart illustrating operations of a computing device according to some embodiments;

FIG. 9 is a block diagram of an example of a computing device that may be used to implement particular embodiments of the present disclosure;

FIG. 10 is a block diagram of a communication system in accordance with some embodiments;

FIG. 11 is a block diagram of a network node in accordance with some embodiments;

FIG. 12 is a block diagram of a host computer communicating with a user equipment in accordance with some embodiments;

FIG. 13 is a block diagram of a virtualization environment in accordance with some embodiments; and

FIG. 14 is a block diagram of a host computer communicating via a BS with a user equipment (UE) over a partially wireless connection in accordance with some embodiments in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents some embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

Some approaches discuss improving/optimizing the state of the charge (SoC) of batteries in the context of including peak shaving (e.g., cutting the power in the utilities when demand from consumers is high), supporting vehicle-to-grid power delivery, and reducing operational costs of mobile operators. Such approaches, except the last category, refer to an architecture to demand response for utility and power transmission lines, which behaves differently from a power system with an integrated local battery in a site for radio communications. Radio communications add nontrivial challenges and new variables in terms of radio network load and target key performance indicators (KPIs).

U.S. Patent Publication No. 20210003974A1 discusses an approach to try to ensure constant power frequency and, thus, to maintain stability of a power grid in the presence of renewable sources of energy. A machine learning (ML) model is discussed to generate operational rules that improve/optimize settings of power generation, power usage, and power storage. To this end, passive monitoring is used of the status of a neighboring electrical device, a household electrical circuit, a neighborhood sub-station, and a power grid. Input features to the ML model are controlled from the power grid frequency variation, which determines the status of the battery, to power serves in a datacenter. Operation is fixed to an incoming reference signal “regulation market” or “market signal”, and modules are enabled via an agent.

Patent publication number WO2017114810A1 discusses a method of demand service, using reinforcement learning (RL), for distribution to the constrained cluster. Control action and exogenous state information are inputs to a second neural network which is connected as an input to the first neural network in a feedback loop. However, the approach only fits the demand response service for utility.

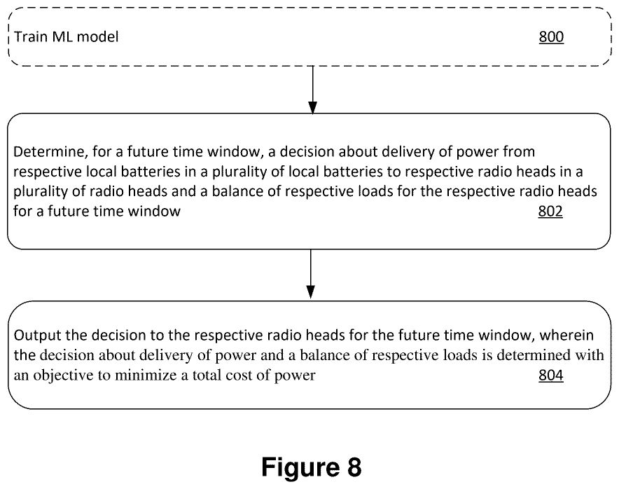

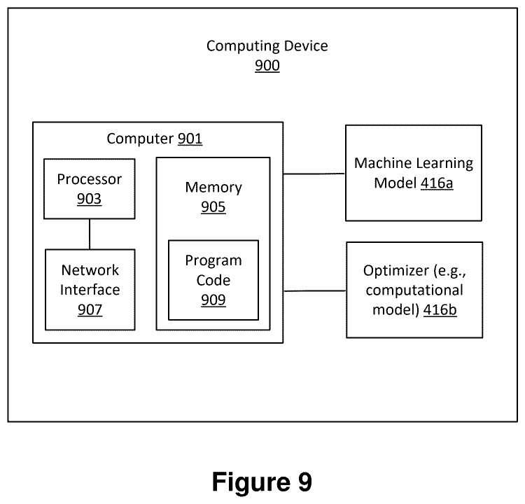

Another approach is. discussed in M. J. E. Alam, K. M. Muttaqi and D. Sutanto, “A Controllable Local Peak-Shaving Strategy for Effective Utilization of PEV Battery Capacity for Distribution Network Support,” IEEE Transactions on Industry Applications, vol. 51, no. 3, pp. 2030-2037 May 2015 (“Alam”). Alam discusses plug-in electric vehicles (PEVs) where unused battery energy may empower a vehicle-to-grid concept. This extra energy source may reduce the stress on the grid during peak load periods. Design of such a vehicle-to-grid concept is discussed, considering limited capacity of the PEV batteries as well as their travel requirements. A limitation of this approach is that the use of a PEV battery, which is only allowed (via a peak shaver index (PSI)) to discharge to a certain level, such as 60%, It is noted that PEV batteries may not be allowed to go down to SoC=0%. See e.g., FIG. 8 of Alam showing randomly selected SoC levels between 60% and 80%. If the PEV battery is used below such a level, the PEV battery may need to be recharged to peak. This may be a significant disadvantage of the approach discussed in Alam. Moreover, to support peak demand, Alam discusses using several PEV to support peak power from one feeder (see e.g., FIG. 9 of Alam).

A. Ahmadian, M. Sedghi, B. Mohammadi-ivatloo, A. Elkamel, M. Aliakbar Golkar and M. Fowler, “Cost-Benefit Analysis of V2G Implementation in Distribution Networks Considering PEVs Battery Degradation,” IEEE Transactions on Sustainable Energy, vol. 9, no. 2, pp. 961-970, April 2018 (“Ahmadian”) discusses a techno-economic framework for a vehicle-to-grid implementation that includes the impact of charging/discharging strategies on the battery pack degradation in the vehicle.

Another approach discusses systems and methods to optimize the SoC of a battery, collocated with one BS site, with the objective of minimizing a cost function of the operator, including e.g. an energy bill or carbon footprint. In this approach, the output power and BS load patterns over time are fixed and given inputs.

Approaches focusing on energy efficiency and improved utilization of resources including power resources from the existing power sources may be lacking. For example, other than the last approach discussed above, the approaches lack consideration of traffic load prediction of mobile networks, battery discharging to various remote radio heads, and the resulting coupling constraints. While the last approach discussed above may consider traffic load prediction for one BS, the approach lacks consideration of the load of other BSs throughout the network and, therefore, lacks jointly engineering the load of the BSs together a SoC optimization.

From a communication service provider's (CSP's) perspective, the usage of batteries may improve BS consumption while at the same time enabling utility services and increasing potential revenue. See e.g., white paper entitled “Ancillary services to utilities using infrastructure”, https://www.ericsson.com/en/reports-and-mobile network power papers/white-papers/balance-smart-grids-with-5g-backup-for-utilities (accessed on 13 Feb. 2023). Meanwhile, new technologies may offer flexibility in joint processing and planning among multiple BSs.

Presently, the main power source of BSs is a power grid, backed up with local batteries to improve the availability of the system in case of a power grid outage. In some cases, the backup capacity may last for hours, which may make them large enough to be included in a normal operational phase of the RAN. However, in some approaches, such capacity is currently limited to emergency cases. Moreover, balancing the load of BSs throughout a communication system (e.g., a mobile network) can affect the output power of the BSs over time. For example, in existing cases, a main objective to balance the load may be fairness, throughput, minimum user equipment (UE) rate, etc.

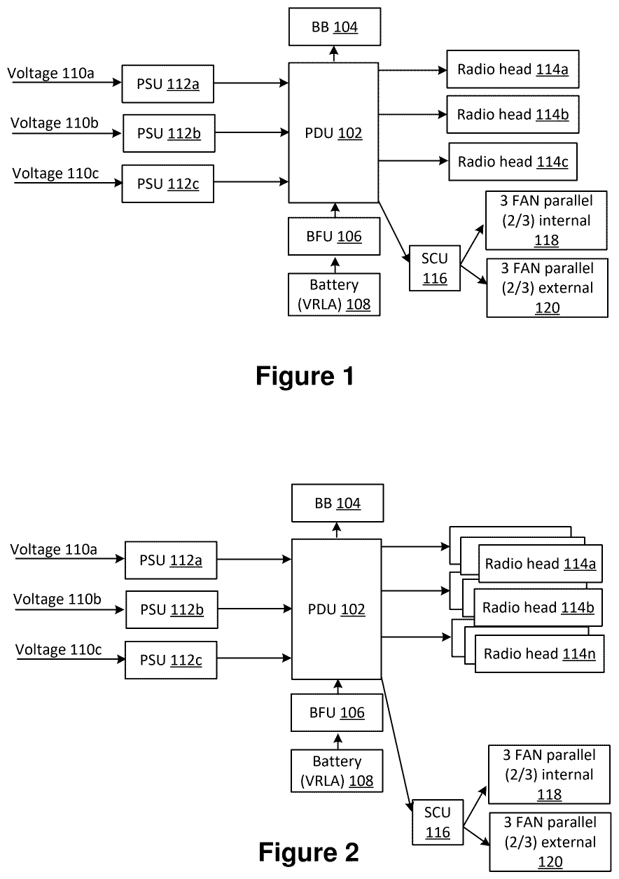

FIG. 1 is a schematic diagram illustrating an example of a conventional site deployment with three radio heads (radio heads 114a-114c). As shown in the example in FIG. 1, the site includes a power distribution unit (PDU 102) communicatively connected to radio heads 114a-114c, as well as to a baseband unit (BB 104), a battery fuse unit (BFU 106) for connecting/disconnecting backup battery 108 (e.g., a value-regulated lead-acid (VRLA) battery), and power supply units (PSUs 112a-112c). Voltages 110a-110c are received at respective PSUs 112a, 112b, 112c. From the PDU 102, power is further delivered to the radio heads 114a-114c, BB 104, and a support control unit (SCU 116). SCU 116 controls, e.g., speeds and/or status of fans 118, 120 for climate control.

FIG. 2 is a schematic diagram illustrating an example of adding more radio heads 114n (e.g., more bands to a site or sector) to the existing example site deployment shown in FIG. 1.

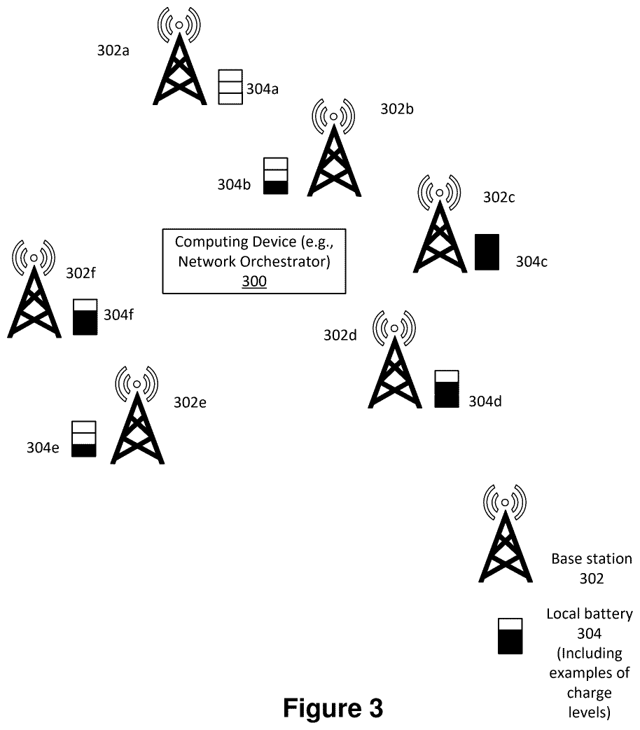

FIG. 3 is a schematic diagram illustrating an example of a RAN with multiple BSs 302a-302f that respectively have one or multiple local batteries 304a-304f in accordance with some embodiments. As illustrated in FIG. 3, the RAN includes a computing device 300 that is, for example, a network orchestrator. Local batteries 304a-304f in this example have different respective example charge levels.

Current technology for site infrastructure energy storage (that is, a battery or batteries) may be designed and used as a backup battery in case of a power outage, as shown in the example in FIGS. 1 and 2. The site battery 108 typically is dimensioned according to local regulations (e.g., hours) and an average power consumption need for each site.

However, by changing such a battery (e.g., battery 108) from a backup power supply to a battery for use as a new active power supply (e.g., local battery 304), operational costs may be reduced (e.g., substantially reduced) as well as reduction of the total carbon footprint, which may be lacking in existing implementations. For example, some approaches may consider SoC optimization at a BS site in isolation without considering the possibility of joint load balancing throughout the network. Load balancing can substantially change a SoC optimization solution, while can also save costs of the operator.

Thus, there appears to be a need for improving site infrastructure in a smart way. For example, by enabling not only optimizing the SoC by a differentiation between average and peak power of radio units in every site, but also loads of various BS sites throughout a RAN. It is noted that optimizing a SoC based on the load of one BS without looking at the RAN and other BS loads may be suboptimal as opposed to joint optimization as discussed further herein.

Certain aspects of the disclosure and their embodiments may provide solutions to these or other challenges. The present disclosure relates to using ML or optimization theory and a computing device (e.g., a network orchestrator) to improve and handle load balancing and SoC optimization throughout a communication system. As referred to herein, a “communication system” includes a telecommunication network that includes an access network, such as a RAN, and a core network.

Operations of examples include determining (1) a balance of the load of BSs throughout a communication system (e.g., a RAN); (2) an improvement/optimization of a SoC of local batteries; and/or (3) a minimization of total cost of operations.

Some embodiments are directed to a method performed by a computing device. As illustrated in FIG. 8, a computer-implemented method is performed by a computing device for load balancing and control of a plurality of local batteries located proximate a plurality of radio heads for a communication system. The method includes determining (802), for a future time window, a decision about delivery of power from respective local batteries in the plurality of local batteries to respective radio heads in the plurality of radio heads and a balance of respective loads for the respective radio heads for a future time window. The method further includes outputting (804) the decision to the respective radio heads for the future time window. The decision about delivery of power and a balance of respective loads is determined with an objective to minimize a total cost of power.

In some examples, local batteries have a new set of functionalities that makes the local battery (or batteries) a supplementary source of power with the option of actively charging and discharging based on engineered loads of their own BSs which may minimize some cost functions for an operator.

Moreover, examples of the present disclosure can operate with existing RAN features (e.g., cell sleep, micro sleep Tx, MIMO-sleep), including radio peak shaving (see e.g., white paper entitled “Ancillary services to utilities using mobile network power infrastructure”, https://www.ericsson.com/en/reports-and-papers/white-papers/balance-smart-grids-with-5g-backup-for-utilities (accessed on 13 Feb. 2023) as a byproduct and a set of constraints on the charging and discharging that may increase the battery lifetime while acting as an active source of power supply.

The computing device can be a RAN orchestrator (e.g., a ML-based RAN orchestrator) that performs operations to jointly optimize the SoC of local batteries and balance BS loads throughout a RAN. The local batteries can include a new set of functionalities that makes the local batteries a supplementary source of power with the option of actively charging and discharging to minimize some cost functions for an operator, for example including energy costs or a carbon footprint of RAN operations. Further, as a byproduct, the operations can enable radio peak shaving.

Technical advantages provided by certain embodiments of the present disclosure may include that based on inclusion of load balancing and control of a plurality of local batteries, new RATs may be added in a sustainable way in parallel with existing RAN features; improved optimization and increased lifetime of the battery(ies), when co-orchestrated of multiple sites, may be achieved; and/or peak power demands may be jointly optimized as well as current grid energy prices and carbon footprint profile. Further technical advantages provided by certain embodiments may include that based on the inclusion of ML, local battery function and control may be enhanced based on optimization of the battery power which also may increase the lifetime of the local battery(ies); and the ML model also may optimize charge and discharge policies of the local battery(ies) for BSs.

For ease of discussion, example embodiments herein are explained in the non-limiting context of the example RAN shown in FIG. 3 that includes six BSs 302; where each BS 302, or a subset of BSs 302, has access to its respective local battery(ies) 304. While FIG. 3, shows six BSs 302 and six local batteries 304, the present disclosure is not so limited. Rather, any plurality of BSs and plurality of local batteries may be included.

Operations of examples herein may minimize a total cost of operation, including the cost of charging the multiple local batteries 304 of a large scale of BSs 302 and the cost of using a power grid at every time (that is, allowing the average power to radio units to come from the site power system), if included in constraints.

Further, operations of examples herein may enable optimization of multiple SoC of local batteries 304 on multiple BSs 302 while optimizing load distribution across the RAN. Examples include a ML-based multiple SoC optimization that includes considering local constraints to enable and deliver power to BSs 302 from two different power sources during normal network operation.

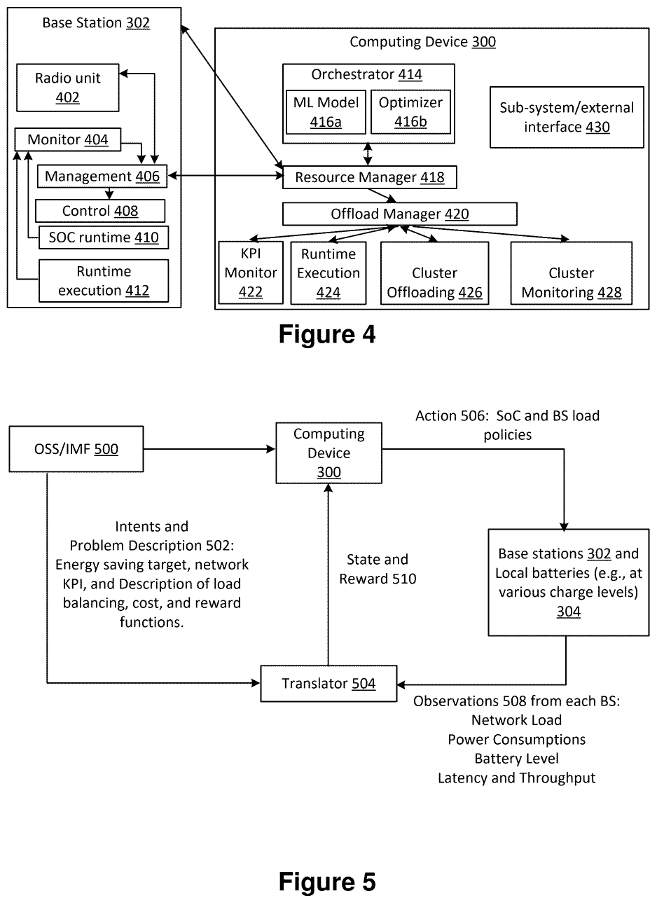

FIGS. 4 and 5 are schematic diagrams illustrating a general architecture for some embodiments. The computing device 300 (e.g., a network orchestrator that can be implemented in a centralized fashion at, for example, a network data analytics function (NWDAF), or in distributed fashion via proper signaling among BSs 302 over an X2 interface) can collect a network status including batteries and loads, and can provide load balancing and battery management determinations for a next time window(s), as discussed further herein.

As shown in the example in FIG. 4, an architecture for joint battery management and load balancing in a RAN includes a BS 302 and a computing device 300. The BS 302 includes a radio unit 402 communicatively coupled to a management module 406. The computing device 300 includes an orchestrator 414, which includes ML model 416a and optimizer 416b; resource manager 418; offload manager 420 and sub-system/external interface 430. Resource manager 418 is communicatively coupled to BS 302, including management module 406. Offload manager 420 is communicatively connected with key performance indicator (KPI) monitor 422, runtime execution module 424, cluster offloading module 426, and cluster monitoring module 428.

As shown in the example of FIG. 5, an architecture for joint battery management and load balancing in a RAN includes multiple BSs 302 having respective local batteries 304 having different battery charge levels. Translator 504 collects relevant information from the RAN including, e.g., load statistics, and statistics of latency, throughput, and local battery 304 levels. Translator 504 processes this information via descriptions provided by operations support system (OSS)/intent management function (IMF) 500 on problem constraints, energy saving targets, as well as how to compute a reward value, and passes the processed information to the ML model 416a deployed at the computing device 300 (e.g., at a network orchestrator) for a new action. Computing device 300 and translator 504 receive, from OSS/IMF 500, intents and a problem description 502. The intents and problem description 502 can include, for example, an energy saving target, a network KPI, a description of load balancing, a cost function, and a reward function. Computing device 300 takes an action 506 based on SoC and BS load policies; and communicates the action to a base station(s) 302 and the BS's 302 local battery(ies) 304. The local batteries 304 can be at various charge levels. Respective BSs 302 communicate a respective observation 508 to translator 504. The observation 508 can include, for example, a network load, a power consumption, a battery level, a latency, and/or a throughput. Translator 504, based on the received intents and problem description 502 and observations 508, communicates a state and reward 510 to computing device 300.

In an example related to optimizing SoC of multiple local batteries 304, as further discussed herein, a day is divided into a set of time windows (e.g., every hour) and decision variables are optimized on every time window. Collected data from power consumptions of radio heads (including radio traffic variations) over time is used to train a ML model (e.g., a RL agent) that receives the following inputs: (1) local battery 304 capacity; (2) Power consumption of all radio units of BSs 302 over the past K windows, for a predefined integer K>0, from which the peak and average power consumption are calculated as a function of new load balancing allocation. This can come from a dataset, a simulator, or from another learned mapping, which can come from an independent ML model; and (3) The costs of charging the local battery 304 in the current window as well as the cost of using a power grid for all BSs 302.

Referring to FIG. 8, in one embodiment, the information about the power consumption of the respective radio heads over a plurality of past time windows is used to calculate a peak and an average power consumption as a function of the balance of the respective radio head loads for the future time window. In another embodiment, the determining (802) is made based upon further inputs comprising (i) a level and/or discharge rate of a respective local battery for the respective radio heads, (ii) information about a power consumption of the respective radio heads over a plurality of past time windows, and (iii) information about the total cost of power, including a cost of power grid utilization and a cost of charging the respective local batteries for the plurality of radio heads in a current time window. In another example, a model of decreasing battery life/battery degradation can be used to estimate the cost of discharging and optionally used as additional information to consider as part of the total cost.

The ML model can optimize at the beginning of every day, for example, a decision to be taken at every (e.g., one hour) window. The decision can include a SoC (e.g., when to charge the local battery 304, and/or when and how much to discharge for each radio unit) as well as load balancing throughout the network. For example, in some embodiments, the decision is based on a first plurality of constraints for the future time window.

In this example, the SOC decision should meet the following set of constraints in every time window:
C1. Constraint 1: The local battery 304 discharge level of any window to a radio head plus power input (e.g., from power cables) at every time should be identical to the output power of that radio head at that time.
C2. Constraint 2: Local battery 304 discharge at every window should not exceed the local battery 304 level at the beginning of this window plus the charging profile limit of that window.
C3. Constraint 3: Current local battery 304 level is identical to the previous local battery 304 level plus extra charges made in this window.
C4. Constraint 4: The local battery 304 level in any window should not exceed the local battery 304 capacity.

In some embodiments, for example, the first plurality of constraints comprise for the time window (i) a first constraint set as a discharge from at least some of the respective local batteries to a respective radio head plus power from the power grid that is identical to an output power of the respective radio head for the time window, and (ii) at least one second constraint set as a charge level, L, of each of the local batteries is constrained to be 0<=L<=C, where C is a charge capacity of the corresponding local battery for the future time window.

Some examples can enable optimal rebalancing the load of BSs 302 throughout a RAN, including but not limited to UE-BS association, device-to-device (D2D) mode, and WiFi offloading. These different approaches may impose their own constraints on the problem. In some embodiments, for example, the decision about the balance of respective loads for the respective radio heads for a future time window comprises a decision about rebalancing of the respective loads of at least some of the radio heads based on at least one of (i) changing a number of User Equipments (UEs) associated with a respective radio head, (ii) configuring at least one UE to operate in a D2D mode, (iii) WiFi offloading of at least one UE, and (iv) changing a transmit power of at least one of the respective radio heads.

Constraints for an example of UE-BS association are now discussed further. In this example, the load of a BS 302 can be increased or offloaded by associating more or fewer number of respective UEs to that BS 302. With user association as the decision variable to control load balancing, the following additional constraints may be included:
C5. Constraint 5: Each UE must be associated with at least one BS.
C6. Constraint 6: If there is no joint UE processing, then a UE should be associated with exactly one BS.
C7. Constraint 7: The potentially serving BS should support the target rate of that UE.

For example, in some embodiments, when the balance of respective loads is based on an association that associates the changing number of UEs with a respective radio head, the load rebalancing is performed when constrained by a second plurality of constraints comprising: (i) a fifth constraint set as each UE is associated with at least one base station comprising a plurality of radio heads; (ii) a sixth constraint set as in the absence of joint processing of UE signals received by a plurality of radios, then a UE is associated with exactly one radio head; and (iii) a seventh constraint set as a target radio head supports a target rate of a UE.

In examples when a high-level load balancing is targeted, only distance-dependent and shadowing (e.g., only large-scale components of a channel, excluding small-scale fast fading) may be considered. Once an optimal SoC and load balancing (e.g., high-level resource allocation) is determined, normal operation of the network can be used, including handover based on instantaneous channel gains. Such small changes in the loads can have a very small, if not negligible, impact on the optimal SoC based on the optimizer changing the SoC only when a large change in the load or the electricity cost (e.g., price or carbon footprint) are detected. For a macro or most micro-BSs, the number of newly handovered UEs to/from the macro/micro-BS generally can be less than the number of UEs already being served in every time slot by the macro/micro-BS.

In another example, load balancing can happen based on (1) the statistics of the loads as well as (2) how much, in theory, how many UEs can be offloaded to or taken from neighboring cells, as functions of time of the day. Then the computing device 300 can use those time series and optimize the load of the BSs 302 as well as a local battery management plan throughout the day based on (1) load constraints, (2) local battery 304 level, and (3) energy cost (e.g., monetary or carbon footprint). Referring again to FIG. 8, in some embodiments, the decision about the balance of respective loads for the respective radio heads for a future time window is based on using (i) statistics of the respective loads for a plurality of past time windows, and (ii) an amount of load that a respective radio head can offload to or take from a neighboring radio head for the plurality of past time windows.

In the above example, the load balancing decision variable can be a matrix whose element (i, j) shows the average number of UEs to be served by BS 302 i in window j. In some embodiments, for example, the decision about the balance of respective loads comprises an average number of user equipment, UE, to be served by a respective radio head in a respective time window for a plurality of different future time windows.

In another example, the network can use a D2D mode or switch to WiFi, if available, to offload some of the BS loads, if needed.

As discussed herein, some examples are based on an optimization theory that includes modelling functions. Other examples, however, are based on ML.

In examples based on optimization theory, an optimization framework (e.g., a computational model or process) can fix load balancing variables, optimize for SoC, take the optimal SoC as a fixed input, and optimize for the load balancing decision variables. An iterative algorithm can continue until a stop criteria is met. Such examples include modeling of all functions, as discussed further herein. Under some general conditions on the objective and constraint functions (see e.g., Razaviyayn, Meisam, Mingyi Hong, and Zhi-Quan Luo. “A unified convergence analysis of block successive minimization methods for nonsmooth optimization.” SIAM Journal on Optimization 23.2 (2013): 1126-1153), alternative operations can converge to a stationary point of this optimization problem. However, for many existing solvers, this involves having closed form expressions of the objective and constraint functions, which may not be feasible in all use cases.

In some embodiments, the determining (operation 802 in FIG. 8) is based on use of a computational process that iterates to (i) minimize a first set of decision variables concerning the respective local batteries and a second set of decision variables concerning the balance of respective loads, subject to (ii) a set of constraints.

In examples based on ML, a ML model is used to learn underlying unknown models, interactions of an action and the environment, and optimize decision variables. The ML model can be trained at the cloud or on the BSs 302 using some distributed computations, and then deployed at a battery management service, located at the local battery 304 of every site as well as at the computing device 300 (e.g., a RAN orchestrator) to balance the network load.

Actions include charge and discharge decisions of the local battery 304 to the radio units as well as the load of BSs 302 in the RAN. In the example of association, the load balancing decision is BS-UE association or a parameter that determines how the association should be decided, such as an average number of UEs to be served by a BS 302. The ML model can then optimize that number for respective BSs 302 throughout the day.

A state can be current local battery 304 level of respective BSs 302, current output power of respective radio heads of respective BSs 302, and current local battery 304 charging cost of all BSs 302.

A reward at a respective state-action can be negative of the total cost of input power in the next window. The cost can be a weighted sum of power from the grid and power from the local battery 304, weighted based on the respective local batteries 304 own costs. Cost can be, for example, monetary cost of energy or a carbon footprint index.

In some embodiments, the determining (operation 802 in FIG. 8) is based on use of a ML model. The ML model receives a state including at least one of a charge level of the respective local batteries, an output power of the respective radio heads, a cost of charging the respective local batteries, and a load of the respective radio heads, and outputs an action comprising the decision.

In one example, for every BS 302 b∈[B]=={1, 2, . . . , B}, a total Rp radio heads is considered, indexed by r_{b}∈[R_{b}]:={1, 2, . . . , R_{b}}, connected to a local battery 304 of capacity C_{b}. In this example, local batteries 304 are also connected to the power grid. Respective decision-making timeframes are divided, e.g. a day is divided into W windows of predefined duration T; and [W] is defined as [W]:=={1, 2, . . . , W}. B_{b,w}, the local battery 304 level, is denoted at the beginning of window w. In respective windows w, each radio head r_{b} has a max power

$${p}_{{r}_{b} w}^{max} ,$$

an average power of

$${p}_{{r}_{b} w}^{avg} ,$$

and a power pᵣ_{_{b}}_{w}(t) at any time t in this window. In respective windows w, the local battery 304 discharges to radio head r_{b} at a constant rate of

$${d}_{{r}_{b} w}^{bat .} \geq 0.$$

Charging the local battery 304 at respective windows w follows a predefined charge profile

$${h}_{bw}^{bat .} ( t )$$

and cost profile of

$${c}_{bw}^{bat .} ( t ) ,$$

leading to a total charge of

$${H}_{bw}^{bat} = {\int }_{t = 0}^{T} {h}_{bw}^{bat .} ( t ) dt$$

with a total cost of

$${C}_{{r}_{b} w}^{bat .} = {\int }_{t = 0}^{T} {d}_{{r}_{b} w}^{bat .} {c}_{bw}^{bat .} ( t ) dt$$

during this window. Moreover, using the grid at respective windows w follows a predefined cost profile of

$${c}_{bw}^{g} ( t ) ,$$

leading to a total cost of

$${c}_{{r}_{b} w}^{g} = {\int }_{t = 0}^{T} {d}_{{r}_{b} w}^{g} ( t ) {c}_{w}^{g} ( t ) dt ,$$

where

$${d}_{{r}_{b} w}^{g} ( t )$$

is the power grid usage at time t for radio head i. In this example, the following constraints are at respective windows:
C1: Output power:

$${d}_{{r}_{b} w}^{bat .} + {d}_{{r}_{b} w}^{g} = {p}_{{r}_{b} w} ( t )$$

for respective radio heads/units and respective BSs 302.
C2: Local battery 304 level (including Constraints 2-4 discussed above):

$${B}_{w} + {H}_{w}^{bat .} - {Td}_{{r}_{b} w}^{bat} ∈ [ 0 , {C}_{b} ]$$

for respective BSs 302 b.

In this example, the cost of operation (e.g., energy bill) in respective time windows is

$${C}_{{r}_{b} w}^{bat .} + {C}_{bw}^{g}$$

leading to an energy objective of

$${f}_{e} := ( {\sum }_{b ∈ [ B ] , {r}_{b} ∈ [ {R}_{b} ] , w ∈ [ W ]} {C}_{{r}_{b} , w}^{bat .} + {C}_{{r}_{b} w}^{g} )$$

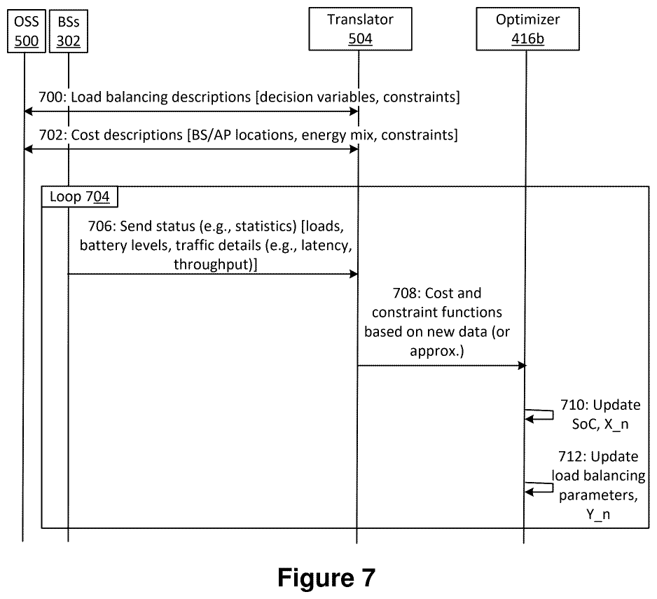

for the entire network. fₑ is the energy cost (in other words, an objective) to be maximized. Additionally, other intents can be communicated via IMF/OSS 500 including for example, but not limited to, increased throughput and/or reducing latency. The additional intents are denoted by fᵢ. In this example, thus, the objective is to maximize the function of fₑ and fᵢ, for example a convex combination of the fₑ and fᵢ. The ultimate function can be denoted by f. The exact structure of f and how to map fₑ and fᵢ to f is communicated to the optimizer 416b at the beginning, via IMF/OSS 500, as shown in the example in FIG. 7. Thus, in this example the optimization problem can be formulated as:

$$\begin{matrix}minimize & f \\ subject to & C 1 , C 2 , C 5 , C 6 , C 7\end{matrix}$$

This optimization problem in this example can be solved based on optimization theory that includes modelling functions; or based on ML. In some embodiments, the decision of operation 802 of FIG. 8 includes the balance of the load for the plurality of radio heads and at least one of the following for the future time window (i) deliver power from at least some of the respective local batteries to at least some of the respective radio heads during the future time window, (ii) charge at least some of the respective local batteries during the future time window, and (iii) deliver no power from at least some of the respective local batteries to at least some of the respective radio heads during the future time window.

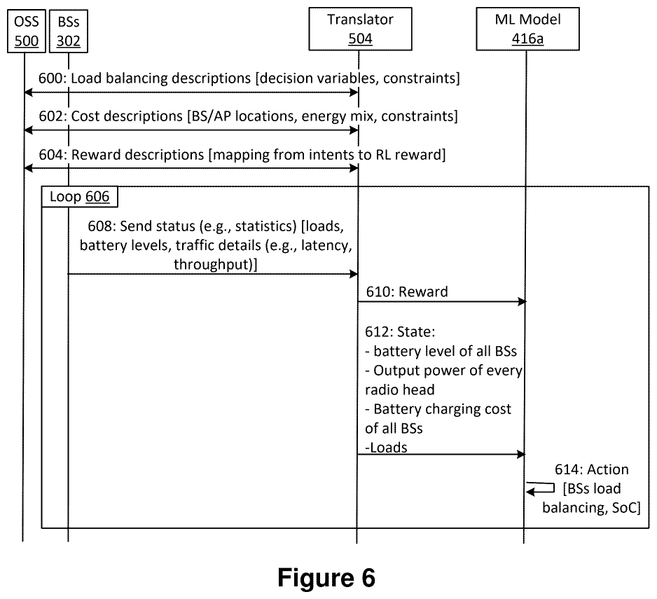

FIG. 6 is a sequence diagram illustrating an example of ML-based load balancing and local battery management service. In operations 600, 602, and 604, the translator 504 (e.g. a data processor) receives a problem description from OSS/IMF 500. The information includes descriptions of load balancing, cost, and reward, which is a function of intents set by XF. Examples of these descriptions include the following:
Load balancing description 600: Describes decision variables (in the case of association, e.g., binary BS-UE association variable), constraints (e.g., C5, C6, and C7 for a case of association).
Cost description 602: Information for the translator 504 to develop computational methods for the ML model 416a to measure costs. For example, location of the BSs 302 or access points, energy price at those locations, energy mix being used there (e.g., to be able to compute carbon footprint of every kwh), constraints (e.g., some local batteries 304 may have nonlinear charging cost depending on their battery level).
Reward description: Information to map the intents and the state-action pairs to some reward values to be used by the ML model 416a.

In respective iterations of training loop 606, respective BSs 302 send 608 to translator 504 their status, including statistics of the loads, local battery 304 levels, and UE and cell-wide latency and throughput. In operations 610 and 612, translator 504 computes, using the descriptions given by OSS 500, the reward and state, allowing the ML model 416a to proceed to the next iteration. The operations continue to improve the ML model 416a and actions 614 (BS loading balancing and SoC) and continues loop 606 to find the optimal load balancing and local battery management policies. Subsequently, the ML model 416a can be deployed at a battery management service for respective sites and the KPIs are monitored for potential retraining/tunning of the ML model 416a.

Referring to FIG. 8, in some embodiments, the method further includes training (800) the ML model. The training includes iterating on receiving the state, outputting the action and receiving a reward feedback for a respective state and action pair in an iteration.

FIG. 7 is a sequence diagram illustrating an example of optimization theory-based load balancing and local battery management service. In this example, the set of decision variables concerning the local batteries 304 is denoted by

$$X = \{ {d}_{rbw}^{bat} , {h}_{bw}^{bat} ( t ) , {d}_{rbw}^{g} ( t ) \}$$

and the set of decision variables concerning load balancing is denoted by Y. In this example, the optimization problem can be rewritten in compact form as:

$$\begin{matrix}minimize & f ( X , Y ) \\ subject to & {C}_{i} ( X , Y ) ∀ i\end{matrix}$$

where the dependencies of the objective and constraint functions to the decision variables are highlighted.

In operations 700 and 702, the translator 504 (e.g. a data processor) receives the problem description from OSS 500. The information includes the descriptions of load balancing and cost, which is a function of intents set by XF. Examples of these descriptions include the following:
Load balancing description 700: Describes decision variables (in the case of association, e.g., binary BS-UE association variable), constraints (e.g., C5, C6, and C7 for a case of association).
Cost description 702: Information for the translator 504 to model costs for the optimizer 416b. For example, including location of the BSs 302 or access points, energy price at those locations, energy mix being used there (e.g., to be able to compute carbon footprint of every kwh), constraints (e.g., some local batteries 304 may have nonlinear charging cost depending on their battery level).

In operation 706 of loop 704, respective BSs 302 send to translator 504 their status, including statistics of the loads, local battery 304 levels, and UE and cell-wide latency and throughput. Starting from initial values (X₀, Y₀), operation 708 of training loop 704 follows the following iterations:

$$\begin{matrix}{X}_{n + 1} ∈ arg {min}_{x} & f ( X , {Y}_{n} ) \\ subject to & {C}_{i} ( X , {Y}_{n} ) ∀ i\end{matrix}$$

$$and$$

$$\begin{matrix}{Y}_{n + 1} ∈ arg {min}_{y} & f ( {X}_{n + 1} , Y ) \\ subject to & {C}_{i} ( {X}_{n + 1} , Y ) ∀ i\end{matrix}$$

In operations 710 and 712, respectively, optimizer 416b updates the SoC, Xₙ and the load balancing parameters, Yn. The operations of loop 704 continue to improve the optimizer 416b and updates 710, 712 to find the optimal load balancing and local battery management policies. Subsequently, optimizer 416b is deployed at a battery management service for respective sites and the KPIs are monitored for potential retraining/tunning of the optimizer 416b.

Operations of a computing device can be performed by the computing device 900 of FIG. 9. In some embodiments, the computing device is located at one of proximate the plurality of local batteries and a cloud-based location.

Operations of the computing device (implemented using the structure of FIG. 9) have been discussed with reference to the flow chart of FIG. 8 according to some embodiments of the present disclosure. For example, modules may be stored in memory 905, ML model 416a, or optimizer 416b (e.g., a computational model) of FIG. 9, and these modules may provide instructions so that when the instructions of a module are executed by respective computing device processing circuitry 903, computing device 708 performs respective operations of the flow chart.

In some embodiments of computing devices and related methods, operations from the flow chart of FIG. 8 may be optional. For example, the operations of block 800 may be optional.

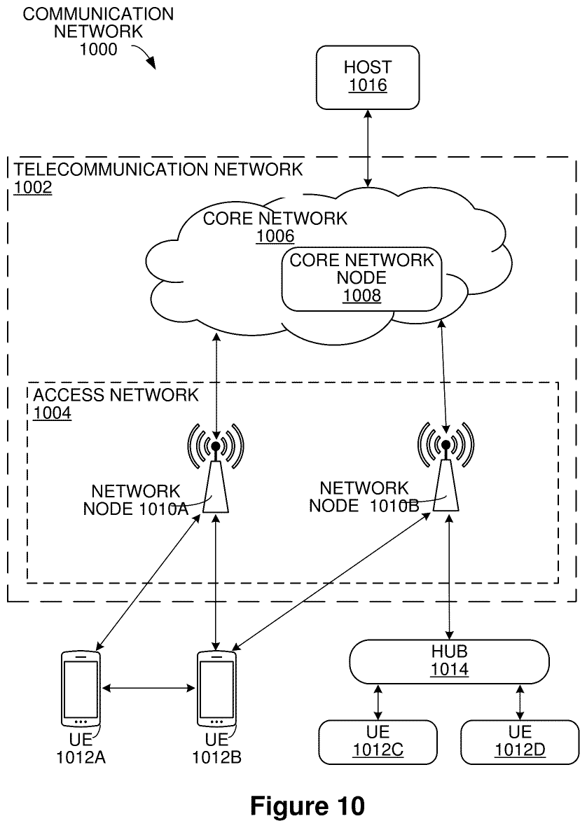

FIG. 10 shows an example of a communication system 1000 in accordance with some embodiments.

In the example, the communication system 1000 includes a telecommunication network 1002 that includes an access network 1004, such as a RAN, and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of UE, such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

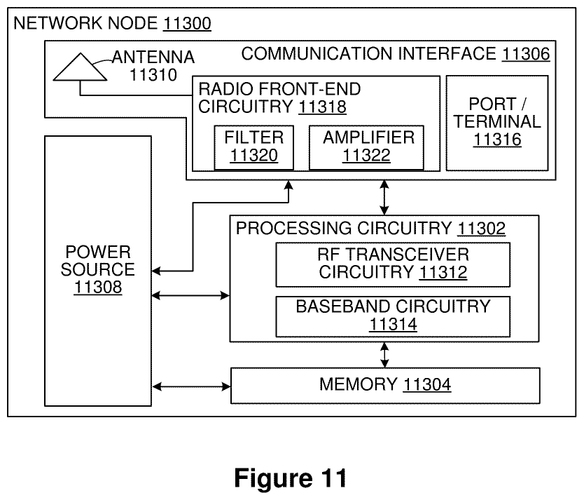

FIG. 11 shows a network node 11300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), BSs (e.g., radio base stations, Node Bs, evolved Node Bs (eNBs) and NR NodeBs (gNBs)).

BSs may be categorized based on the amount of coverage they provide (or, stated differently, their transmit power level) and so, depending on the provided amount of coverage, may be referred to as femto base stations, pico base stations, micro base stations, or macro base stations. A BS may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 11300 includes a processing circuitry 11302, a memory 11304, a communication interface 11306, and a power source 11308. The network node 11300 may be composed of multiple physically separate components (e.g., a NodeB component and a RNC component, or a BTS component and a BSC component, etc.), which may each have their own respective components. In certain scenarios in which the network node 11300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 11300 may be configured to support multiple RATs. In such embodiments, some components may be duplicated (e.g., separate memory 11304 for different RATs) and some components may be reused (e.g., a same antenna 11310 may be shared by different RATs). The network node 11300 may also include multiple sets of the various illustrated components for different wireless technologies integrated into network node 11300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 11300.

The processing circuitry 11302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 11300 components, such as the memory 11304, to provide network node 11300 functionality.

In some embodiments, the processing circuitry 11302 includes a system on a chip. In some embodiments, the processing circuitry 11302 includes one or more of radio frequency (RF) transceiver circuitry 11312 and baseband processing circuitry 11314. In some embodiments, the radio frequency (RF) transceiver circuitry 11312 and the baseband processing circuitry 11314 may be on separate chips (or sets of chips), boards, or units, such as radio units and digital units. In alternative embodiments, part or all of RF transceiver circuitry 11312 and baseband processing circuitry 11314 may be on the same chip or set of chips, boards, or units.

The memory 11304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 11302. The memory 11304 may store any suitable instructions, data, or information, including a computer program, software, an application including one or more of logic, rules, code, tables, and/or other instructions capable of being executed by the processing circuitry 11302 and utilized by the network node 11300. The memory 11304 may be used to store any calculations made by the processing circuitry 11302 and/or any data received via the communication interface 11306. In some embodiments, the processing circuitry 11302 and memory 11304 is integrated.

The communication interface 11306 is used in wired or wireless communication of signaling and/or data between a network node, access network, and/or UE. As illustrated, the communication interface 11306 comprises port(s)/terminal(s) 11316 to send and receive data, for example to and from a network over a wired connection. The communication interface 11306 also includes radio front-end circuitry 11318 that may be coupled to, or in certain embodiments a part of, the antenna 11310. Radio front-end circuitry 11318 comprises filters 11320 and amplifiers 11322. The radio front-end circuitry 11318 may be connected to an antenna 11310 and processing circuitry 11302. The radio front-end circuitry may be configured to condition signals communicated between antenna 11310 and processing circuitry 11302. The radio front-end circuitry 11318 may receive digital data that is to be sent out to other network nodes or UEs via a wireless connection. The radio front-end circuitry 11318 may convert the digital data into a radio signal having the appropriate channel and bandwidth parameters using a combination of filters 11320 and/or amplifiers 11322. The radio signal may then be transmitted via the antenna 11310. Similarly, when receiving data, the antenna 11310 may collect radio signals which are then converted into digital data by the radio front-end circuitry 11318. The digital data may be passed to the processing circuitry 11302. In other embodiments, the communication interface may comprise different components and/or different combinations of components.

In certain alternative embodiments, the network node 11300 does not include separate radio front-end circuitry 11318, instead, the processing circuitry 11302 includes radio front-end circuitry and is connected to the antenna 11310. Similarly, in some embodiments, all or some of the RF transceiver circuitry 11312 is part of the communication interface 11306. In still other embodiments, the communication interface 11306 includes one or more ports or terminals 11316, the radio front-end circuitry 11318, and the RF transceiver circuitry 11312, as part of a radio unit (not shown), and the communication interface 11306 communicates with the baseband processing circuitry 11314, which is part of a digital unit (not shown).

The antenna 11310 may include one or more antennas, or antenna arrays, configured to send and/or receive wireless signals. The antenna 11310 may be coupled to the radio front-end circuitry 11318 and may be any type of antenna capable of transmitting and receiving data and/or signals wirelessly. In certain embodiments, the antenna 11310 is separate from the network node 11300 and connectable to the network node 11300 through an interface or port.

The antenna 11310, communication interface 11306, and/or the processing circuitry 11302 may be configured to perform any receiving operations and/or certain obtaining operations described herein as being performed by the network node. Any information, data and/or signals may be received from a UE, another network node and/or any other network equipment. Similarly, the antenna 11310, the communication interface 11306, and/or the processing circuitry 11302 may be configured to perform any transmitting operations described herein as being performed by the network node. Any information, data and/or signals may be transmitted to a UE, another network node and/or any other network equipment.

The power source 11308 provides power to the various components of network node 11300 in a form suitable for the respective components (e.g., at a voltage and current level needed for each respective component). The power source 11308 may further comprise, or be coupled to, power management circuitry to supply the components of the network node 11300 with power for performing the functionality described herein. For example, the network node 11300 may be connectable to an external power source (e.g., the power grid, an electricity outlet) via an input circuitry or interface such as an electrical cable, whereby the external power source supplies power to power circuitry of the power source 11308. As a further example, the power source 11308 may comprise a source of power in the form of a battery or battery pack which is connected to, or integrated in, power circuitry. The battery may provide backup power should the external power source fail.

Embodiments of the network node 11300 may include additional components beyond those shown in FIG. 11 for providing certain aspects of the network node's functionality, including any of the functionality described herein and/or any functionality necessary to support the subject matter described herein. For example, the network node 11300 may include user interface equipment to allow input of information into the network node 11300 and to allow output of information from the network node 11300. This may allow a user to perform diagnostic, maintenance, repair, and other administrative functions for the network node 11300.

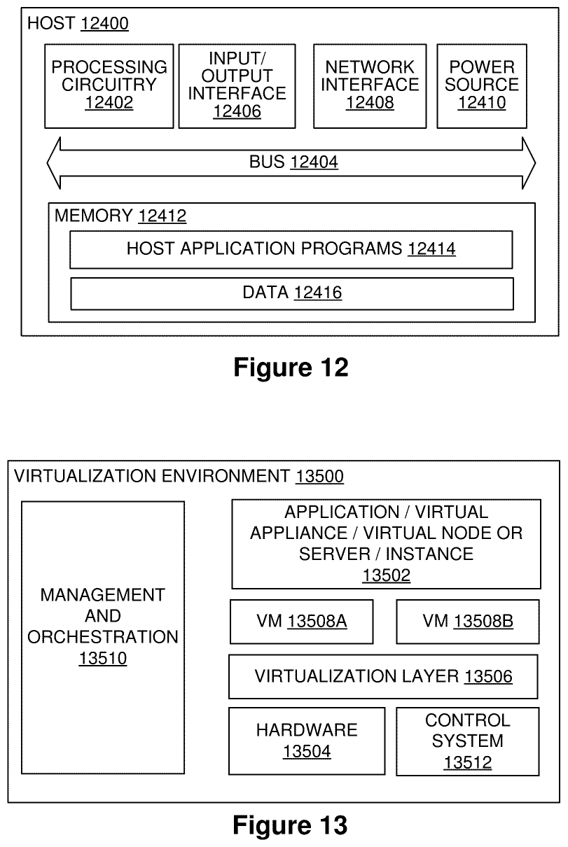

FIG. 12 is a block diagram of a host 12400, which may be an embodiment of the host 1016 of FIG. 10, in accordance with various aspects described herein. As used herein, the host 12400 may be or comprise various combinations hardware and/or software, including a standalone server, a blade server, a cloud-implemented server, a distributed server, a virtual machine, container, or processing resources in a server farm. The host 12400 may provide one or more services to one or more UEs.

The host 12400 includes processing circuitry 12402 that is operatively coupled via a bus 12404 to an input/output interface 12406, a network interface 12408, a power source 12410, and a memory 12412. Other components may be included in other embodiments. Features of these components may be substantially similar to those described with respect to the devices of previous figures, such as FIG. 11, such that the descriptions thereof are generally applicable to the corresponding components of host 12400.

The memory 12412 may include one or more computer programs including one or more host application programs 12414 and data 12416, which may include user data, e.g., data generated by a UE for the host 12400 or data generated by the host 12400 for a UE. Embodiments of the host 12400 may utilize only a subset or all of the components shown. The host application programs 12414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 12414 may also provide for user authentication and licensing checks and may periodically report health, routes, and content availability to a central node, such as a device in or on the edge of a core network. Accordingly, the host 12400 may select and/or indicate a different host for over-the-top services for a UE. The host application programs 12414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 13500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 13500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 13502 (which may alternatively be called software instances, virtual appliances, network functions, virtual nodes, virtual network functions, etc.) are run in the virtualization environment 13500 to implement some of the features, functions, and/or benefits of some of the embodiments disclosed herein.

Hardware 13504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 13506 (also referred to as hypervisors or virtual machine monitors (VMMs)), provide VMs 13508a and 13508b (one or more of which may be generally referred to as VMs 13508), and/or perform any of the functions, features and/or benefits described in relation with some embodiments described herein. The virtualization layer 13506 may present a virtual operating platform that appears like networking hardware to the VMs 13508.

The VMs 13508 comprise virtual processing, virtual memory, virtual networking or interface and virtual storage, and may be run by a corresponding virtualization layer 13506. Different embodiments of the instance of a virtual appliance 13502 may be implemented on one or more of VMs 13508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 13508 may be a software implementation of a physical machine that runs programs as if they were executing on a physical, non-virtualized machine. Each of the VMs 13508, and that part of hardware 13504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 13508 on top of the hardware 13504 and corresponds to the application 13502.

Hardware 13504 may be implemented in a standalone network node with generic or specific components. Hardware 13504 may implement some functions via virtualization. Alternatively, hardware 13504 may be part of a larger cluster of hardware (e.g. such as in a data center or CPE) where many hardware nodes work together and are managed via management and orchestration 13510, which, among others, oversees lifecycle management of applications 13502. In some embodiments, hardware 13504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 13512 which may alternatively be used for communication between hardware nodes and radio units.

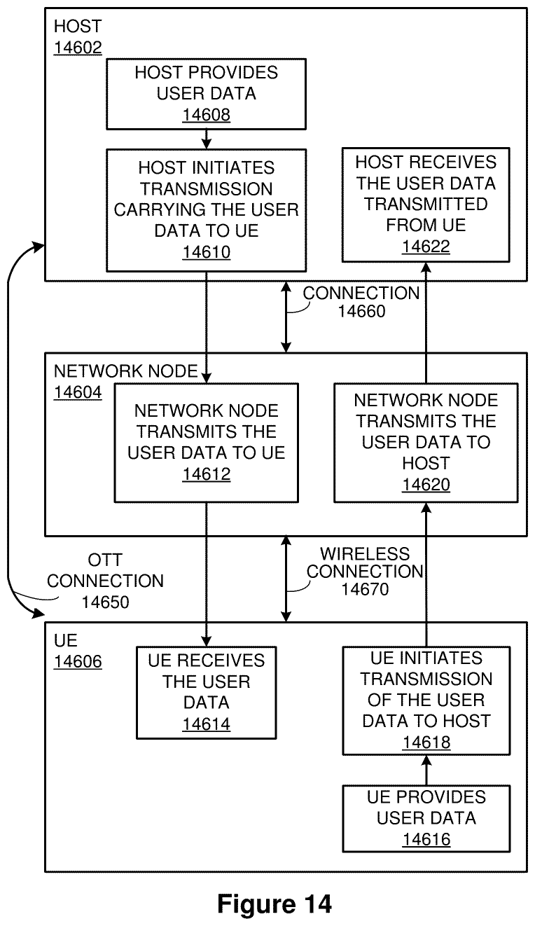

FIG. 14 shows a communication diagram of a host 14602 communicating via a network node 14604 with a UE 14606 over a partially wireless connection in accordance with some embodiments. Example implementations, in accordance with various embodiments, of the UE (such as a UE 1012a of FIG. 10), network node (such as network node 1010a of FIG. 10 and/or network node 11300 of FIG. 11), and host (such as host 1016 of FIG. 10 and/or host 12400 of FIG. 12) discussed in the preceding paragraphs will now be described with reference to FIG. 14.

Like host 12400, embodiments of host 14602 include hardware, such as a communication interface, processing circuitry, and memory. The host 14602 also includes software, which is stored in or accessible by the host 14602 and executable by the processing circuitry. The software includes a host application that may be operable to provide a service to a remote user, such as the UE 14606 connecting via an over-the-top (OTT) connection 14650 extending between the UE 14606 and host 14602. In providing the service to the remote user, a host application may provide user data which is transmitted using the OTT connection 14650.

The network node 14604 includes hardware enabling it to communicate with the host 14602 and UE 14606. The connection 14660 may be direct or pass through a core network (like core network 1006 of FIG. 10) and/or one or more other intermediate networks, such as one or more public, private, or hosted networks. For example, an intermediate network may be a backbone network or the Internet.

The UE 14606 includes hardware and software, which is stored in or accessible by UE 14606 and executable by the UE's processing circuitry. The software includes a client application, such as a web browser or operator-specific “app” that may be operable to provide a service to a human or non-human user via UE 14606 with the support of the host 14602. In the host 14602, an executing host application may communicate with the executing client application via the OTT connection 14650 terminating at the UE 14606 and host 14602. In providing the service to the user, the UE's client application may receive request data from the host's host application and provide user data in response to the request data. The OTT connection 14650 may transfer both the request data and the user data. The UE's client application may interact with the user to generate the user data that it provides to the host application through the OTT connection 14650.

The OTT connection 14650 may extend via a connection 14660 between the host 14602 and the network node 14604 and via a wireless connection 14670 between the network node 14604 and the UE 14606 to provide the connection between the host 14602 and the UE 14606. The connection 14660 and wireless connection 14670, over which the OTT connection 14650 may be provided, have been drawn abstractly to illustrate the communication between the host 14602 and the UE 14606 via the network node 14604, without explicit reference to any intermediary devices and the precise routing of messages via these devices.

As an example of transmitting data via the OTT connection 14650, in step 14608, the host 14602 provides user data, which may be performed by executing a host application. In some embodiments, the user data is associated with a particular human user interacting with the UE 14606. In other embodiments, the user data is associated with a UE 14606 that shares data with the host 14602 without explicit human interaction. In step 14610, the host 14602 initiates a transmission carrying the user data towards the UE 14606. The host 14602 may initiate the transmission responsive to a request transmitted by the UE 14606. The request may be caused by human interaction with the UE 14606 or by operation of the client application executing on the UE 14606. The transmission may pass via the network node 14604, in accordance with the teachings of the embodiments described throughout this disclosure. Accordingly, in step 14612, the network node 14604 transmits to the UE 14606 the user data that was carried in the transmission that the host 14602 initiated, in accordance with the teachings of the embodiments described throughout this disclosure. In step 14614, the UE 14606 receives the user data carried in the transmission, which may be performed by a client application executed on the UE 14606 associated with the host application executed by the host 14602.

In some examples, the UE 14606 executes a client application which provides user data to the host 14602. The user data may be provided in reaction or response to the data received from the host 14602. Accordingly, in step 14616, the UE 14606 may provide user data, which may be performed by executing the client application. In providing the user data, the client application may further consider user input received from the user via an input/output interface of the UE 14606. Regardless of the specific manner in which the user data was provided, the UE 14606 initiates, in step 14618, transmission of the user data towards the host 14602 via the network node 14604. In step 14620, in accordance with the teachings of the embodiments described throughout this disclosure, the network node 14604 receives user data from the UE 14606 and initiates transmission of the received user data towards the host 14602.

In step 14622, the host 14602 receives the user data carried in the transmission initiated by the UE 14606.

One or more of the various embodiments improve the performance of OTT services provided to the UE 14606 using the OTT connection 14650, in which the wireless connection 14670 forms the last segment. More precisely, the teachings of these embodiments may improve the latency or throughput and thereby provide benefits such as extended battery lifetime.

In an example scenario, factory status information may be collected and analyzed by the host 14602. As another example, the host 14602 may process audio and video data which may have been retrieved from a UE for use in creating maps. As another example, the host 14602 may collect and analyze real-time data to assist in controlling vehicle congestion (e.g., controlling traffic lights). As another example, the host 14602 may store surveillance video uploaded by a UE. As another example, the host 14602 may store or control access to media content such as video, audio, VR or AR which it can broadcast, multicast or unicast to UEs. As other examples, the host 14602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 14650 between the host 14602 and UE 14606, in response to variations in the measurement results. The measurement procedure and/or the network functionality for reconfiguring the OTT connection may be implemented in software and hardware of the host 14602 and/or UE 14606. In some embodiments, sensors (not shown) may be deployed in or in association with other devices through which the OTT connection 14650 passes; the sensors may participate in the measurement procedure by supplying values of the monitored quantities exemplified above, or supplying values of other physical quantities from which software may compute or estimate the monitored quantities. The reconfiguring of the OTT connection 14650 may include message format, retransmission settings, preferred routing etc.; the reconfiguring need not directly alter the operation of the network node 14604. Such procedures and functionalities may be known and practiced in the art. In certain embodiments, measurements may involve proprietary UE signaling that facilitates measurements of throughput, propagation times, latency and the like, by the host 14602. The measurements may be implemented in that software causes messages to be transmitted, in particular empty or ‘dummy’ messages, using the OTT connection 14650 while monitoring propagation times, errors, etc.

Although the computing devices described herein (e.g., UEs, mobile devices, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method performed by a computing device for load balancing and control of a plurality of local batteries located proximate a plurality of radio heads for a communication system, the method comprising:
determining, for a future time window, a decision about delivery of power from respective local batteries in the plurality of local batteries to respective radio heads in the plurality of radio heads and a balance of respective loads for the respective radio heads for a future time window; and
outputting the decision to the respective radio heads for the future time window, wherein the decision about delivery of power and a balance of respective loads is determined with an objective to minimize a total cost of power.

2. The method of claim 1, wherein the determining is made based upon further inputs comprising (i) a level and/or discharge rate of a respective local battery for the respective radio heads, (ii) information about a power consumption of the respective radio heads over a plurality of past time windows, and (iii) information about the total cost of power, including a cost of power grid utilization and a cost of charging the respective local batteries for the plurality of radio heads in a current time window.

3. The method of claim 2, wherein the information about the power consumption of the respective radio heads over a plurality of past time windows is used to calculate a peak and an average power consumption as a function of the balance of the respective radio head loads for the future time window.

4. The method of claim 1, wherein the decision is based on a first plurality of constraints for the future time window.

5. The method of claim 4, wherein the first plurality of constraints comprise for the time window
(i) a first constraint set as a discharge from at least some of the respective local batteries to a respective radio head plus power from the power grid that is identical to an output power of the respective radio head for the time window, and
(ii) at least one second constraint set as a charge level, L, of each of the local batteries is constrained to be 0<=L<=C, where Cis a charge capacity of the corresponding local battery, and L depends on the decision about delivery of power from the corresponding local battery for the future time window.

6. The method of claim 2, wherein the decision about the balance of respective loads for the respective radio heads for a future time window comprises a decision about rebalancing of the respective loads of at least some of the radio heads based on at least one of (i) changing a number of User Equipments, UEs, associated with a respective radio head, (ii) configuring at least one UE to operate in a device-to-device, D2D, mode, (iii) WiFi offloading of at least one UE, and (iv) changing a transmit power of at least one of the respective radio heads.

7. The method of claim 6, wherein when the balance of respective loads is based on an association that associates the changing number of UEs with a respective radio head, the load rebalancing is performed when constrained by a second plurality of constraints comprising:
(i) a fifth constraint set as each UE is associated with at least one base station comprising a plurality of radio heads;
(ii) a sixth constraint set as in the absence of joint processing of UE signals received by a plurality of radios, then a UE is associated with exactly one radio head; and
(iii) a seventh constraint set as a target radio head supports a target rate of a UE.

8. The method of claim 1, wherein the decision about the balance of respective loads for the respective radio heads for a future time window is based on using (i) statistics of the respective loads for a plurality of past time windows, and (ii) an amount of load that a respective radio head can offload to or take from a neighboring radio head for the plurality of past time windows.

9. The method of claim 1, wherein the decision about the balance of respective loads comprises an average number of user equipment, UE, to be served by a respective radio head in a respective time window for a plurality of different future time windows.

10. The method of claim 1, wherein the determining is based on use of a computational process that iterates to (i) minimize a first set of decision variables concerning the respective local batteries and a second set of decision variables concerning the balance of respective loads, subject to (ii) a set of constraints.

11. The method of claim 1, wherein the determining is based on use of a machine learning, ML, model, wherein the ML model receives a state comprising at least one of a charge level of the respective local batteries, an output power of the respective radio heads, a cost of charging the respective local batteries, and a load of the respective radio heads, and outputs an action comprising the decision.

12. The method of claim 11, further comprising:
training the ML model, wherein the training comprises iterating on receiving the state, outputting the action and receiving a reward feedback for a respective state and action pair in an iteration, and
the reward feedback is a value that minimizes a total cost of input power to the at least one radio head for a next time window in a set of time windows.

13. The method of claim 1, wherein the decision comprises the balance of the load for the plurality of radio heads and at least one of the following for the future time window (i) deliver power from at least some of the respective local batteries to at least some of the respective radio heads during the future time window, (ii) charge at least some of the respective local batteries during the future time window, and (iii) deliver no power from at least some of the respective local batteries to at least some of the respective radio heads during the future time window.

14. The method of claim 1, wherein the computing device is located at one of proximate the plurality of local batteries and a cloud-based location.

15. A computing device for load balancing and control of a plurality of local batteries located proximate a plurality of radio heads for a communication system, the computing device comprising:
at least one processor;
at least one memory connected to the at least one processor and storing program code that is executed by the at least one processor to perform operations comprising:
determine, for a future time window, a decision about delivery of power from respective local batteries in the plurality of local batteries to respective radio heads in the plurality of radio heads and a balance of respective loads for the respective radio heads for a future time window; and
output the decision to the respective radio heads for the future time window, wherein the decision about delivery of power and a balance of respective loads is determined with an objective to minimize a total cost of power.

16. The computing device of claim 15, wherein determine is made based upon further inputs comprising (i) a level and/or discharge rate of a respective local battery for the respective radio heads, (ii) information about a power consumption of the respective radio heads over a plurality of past time windows, and (iii) information about the total cost of power, including a cost of power grid utilization and a cost of charging the respective local batteries for the plurality of radio heads in a current time window.

17-18. (canceled)

19. A computer program product comprising a non-transitory storage medium including program code to be executed by at least one processor of a computing device for load balancing and control of a plurality of local batteries located proximate a plurality of radio heads for a communication system, whereby execution of the program code causes the computing device to perform operations comprising:
determine, for a future time window, a decision about delivery of power from respective local batteries in the plurality of local batteries to respective radio heads in the plurality of radio heads and a balance of respective loads for the respective radio heads for a future time window; and
output the decision to the respective radio heads for the future time window, wherein the decision about delivery of power and a balance of respective loads is determined with an objective to minimize a total cost of power.

20. The computer program product of claim 19, wherein determine is made based upon further inputs comprising (i) a level and/or discharge rate of a respective local battery for the respective radio heads, (ii) information about a power consumption of the respective radio heads over a plurality of past time windows, and (iii) information about the total cost of power, including a cost of power grid utilization and a cost of charging the respective local batteries for the plurality of radio heads in a current time window.

21. The computing device of claim 16, wherein the information about the power consumption of the respective radio heads over a plurality of past time windows is used to calculate a peak and an average power consumption as a function of the balance of the respective radio head loads for the future time window.

22. The computing device of claim 15, wherein the decision is based on a first plurality of constraints for the future time window.
